(19) United States
(12) Patent Application Publication
(10) Pub. No.: US 2002/0042740 A1
(43) Pub. Date: Apr. 11, 2002

(54) Prize awarding method and apparatus via a network

(75) Inventor: Tsugufumi Matsuoka, Osaka (JP)

Correspondence Address: LYON & LYON LLP, 633 WEST FIFTH STREET, SUITE 4700, LOS ANGELES, CA, 90071, US

(73) Assignee: SANYO ELECTRIC CO., LTD.

(21) Appl. No.: 09/823,258

(22) Filed: Mar. 30, 2001

(30) Foreign Application Priority Data
Sep. 22, 2000 (JP) 2000-288061

(51) Int. Cl. G06F 17/60; G06F 17/00

(52) U.S. Cl. 705/14; 463/25

(57) ABSTRACT

It is difficult to attract users to a desired web site, as there are so many sites and web pages to be accessed via the Internet. A prize awarding function is implemented in a mail server. The function communicates with a user. When the user accesses the homepage of the prize provision mechanism, a virtual slot machine starts to rotate. The user can win a prize based on a certain probability, which is adjusted in accordance with the access history of the user to the homepage. The time period necessary to complete the slot machine amusement is also set to a desired value in consideration of what the user wants to do next.

### BACKGROUND OF THE INVENTION

1. Field of the Invention

The present invention relates to a network technology, especially to a method and apparatus for awarding a prize to a user over a network.

2. Description of the Related Art

The World Wide Web (WWW), has greatly changed the style of promotional activities and advertising techniques of companies. Now companies have access to a new and direct communication path to users by constructing web sites, and online shopping over the Internet will no doubt be the core commerce of this century. Companies, regardless of their business type, must seek a way to survive by gaining exposure on the Internet and by catching and exploiting new market trends. People who envisaged the Internet must be amazed at today's situation where for example even the most traditional of industries such as Italian jewelers have their own web sites.

The rapid and immense growth in the number of web sites served to form the basis for the boom in electronic commerce, from a macroscopic perspective. From a more detailed perspective, however, each site becomes lost due to the sheer bulk of information and number of sites. It has become a tiresome job requiring much patience to find what you are looking for on the Internet, as search results often show hundreds of thousands of hits. It is a critical issue for any company having web sites, especially portal sites, to attract and invite new users to their sites, as the number of views plays a very important role in estimating the success of the companies.

### SUMMARY OF THE INVENTION

The objective of the present invention is therefore to provide a method and apparatus which serve to increase the number of page views by awarding a certain type of prize in an online environment.

According to one aspect of the present invention, a method of awarding a prize is provided. The method comprises detecting user access via a network to a predetermined page, initiating a prize awarding process which provides amusement when the access is detected, and allowing the user to win the prize at the end of the process based on a certain probability. The process is carried out at a moderate speed so that the user can understand progress of the process and so that the process is completed before the user gains access to arbitrary information residing inside or outside the page.

Here the term “page” means a unit of information to be viewed by the user via a network and includes HTML/XML and other text-based mark up language pages viewed on a WWW browser. The term “user” can be anyone who participates in the competition. The words “initiating prize awarding process which provides amusement” means for example a series of processes where an online slot machine starts, stops, and rewards a “jackpot” to users.

In the above example, the execution speed of a computer is adjusted or decreased so that the user can see the rotation of figures in the windows of the slot machine. The computer can usually respond immediately to the user if he/she wins a prize, as the result simply depends on the predetermined probability in the program. However, in order to make the process entertaining, the process is carried out at such a speed that the user becomes interested and mentally involved.

The phrase “the process is completed before the user gains access to arbitrary information residing inside or outside the page” has at least two considerations. The first is that the process is designed not to be too time-consuming. The user may need to search for information on the web after the prize giving process, which, if too long, may discourage the user. The second is that the user's access to arbitrary information is to be restricted until after the process is completed. The user might miss getting the prize even when he/she wins it unless he/she waits for the result. To prevent this, any further action by the user is temporarily halted.

According to another aspect, the process is not necessarily finished before the user accesses information inside or outside the page. It is deemed sufficient that the process is conducted in such a manner that the user can understand what is taking place, without the necessity of completion of the process.

According to another aspect of the present invention, a prize giving method is provided. The method comprises detecting user access via a network to a predetermined page, initiation of the prize giving process which provides amusement when access is detected, allowing the user to win the prize at the end of the process based on a certain probability, and manipulating the probability based on frequency of access by the user.

Generally, the probability is automatically calculated from the number of winners in relation to the number of applicants. In this respect, the probability is manipulated. The probability may be decreased to a certain value or to zero for a user whose access frequency is relatively high over a relatively short period of time. Users will realize, sooner or later, that automatic frequent access does not win a prize. Users may be made aware of the manipulation by displaying a message such as “Your bet becomes invalid if you access more than thirty times in five minutes” and the like.

The frequency may be evaluated using multi-resolutional analysis and the probability may be adjusted according to the resultant evaluation. The multi-resolutional analysis may be conducted by evaluating the frequency in a plurality of different time spans or time frames. The first of the time spans may be a day, for example, and the user access may be checked and recorded daily. When a certain user accesses for ten days consecutively, the probability for the user may be increased. The second time span, for example, may be five minutes. When a certain user is detected to have accessed more than thirty times in this span, then the access record of the user for the day may be deleted in order not to increase the probability based on the first time span. Naturally, the probability may be directly decreased in this case. By introducing plural time frames, it may be easier to distinguish meaningful user access from meaningless ones and to reward users undertaking meaningful access.

According to still another aspect of the present invention, a prize giving apparatus is provided. The apparatus comprises a detector which detects user access via a network to a predetermined page, a process storage which stores a prize awarding process providing amusement executed for the user, a process initiator which initiates the process when the access is detected, and a prize manager which allows the user win the prize at the end of the process based on a certain probability. The process is carried out at a moderate speed so that the user can understand progress of the process and so that the process is completed before the user gets access to arbitrary information residing inside or outside the page.

According to yet another aspect of the present invention, a prize awarding apparatus is provided. The apparatus comprises the detector, the process storage, the process initiator, the prize manager and a probability adjusting unit which manipulates the probability in accordance with frequency of access by the user.

This summary of the invention does not necessarily describe all necessary features so that the invention may also be a sub-combination of these described features.

### BRIEF DESCRIPTION OF THE DRAWINGS

FIG. 1 is a network system to which a prize awarding apparatus according to one embodiment of the present invention is applied;

FIG. 2 is a block diagram of the prize awarding apparatus;

FIG. 3 shows a screen displayed on the user terminal when the prize giving process is initiated;

FIG. 4 shows a screen displayed when the user wins a prize;

FIGS. 5a and 5b show screens displayed on the terminal where prize sponsors are embedded in the prize process;

FIG. 6 shows a procedure to adjust the prize winning probability; and

FIG. 7 shows a flowchart of the prize process initiated by the prize awarding apparatus.

### DETAILED DESCRIPTION OF THE INVENTION

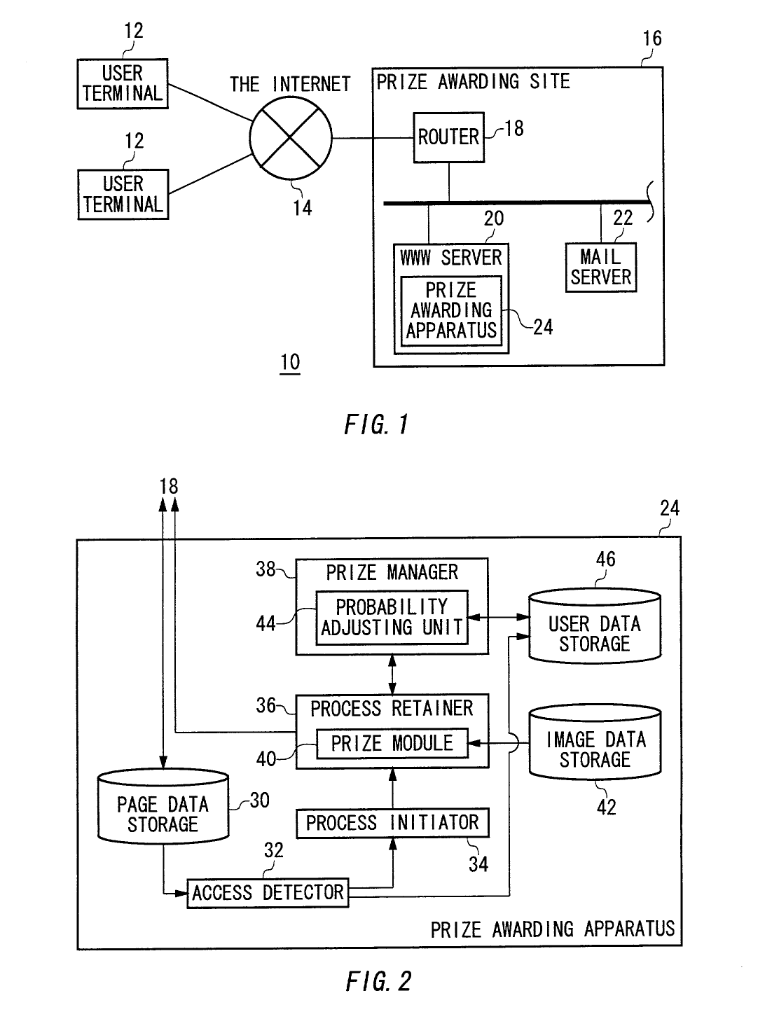

FIG. 1 is the whole network system 10 including a preferred embodiment of a prize awarding apparatus 24. User terminals 12 and prize awarding site 16 are connected via the internet 14. The user terminal 12 may be PCs, PDA's, mobile phones connectable to the internet 14, or any other hardware. The prize awarding site 16 may be an ordinary site, an ISP or Internet service provider for user terminals or a general portal site for classifying web information for users. Hereinafter the prize awarding site 16 is described as a portal site and the user terminal 12's browser first displays the homepage of the prize awarding site 16 when connected to the internet 14.

The prize awarding site 16 comprises a mail server 22, a WWW server 20 and a DNS server (not shown) which communicates to/from the internet 14 via a router 18. The prize awarding apparatus 24 is implemented inside the mail server 22 in this embodiment, but it may be independent or outside of the mail server 22. Naturally other configurations are also possible.

FIG. 2 shows the structure of the prize awarding apparatus 24. The functional blocks here can be realized with hardware circuitry including a CPU, memory and other LSI components of the mail server 22, or with software modules including a prize provision program loaded in the memory. FIG. 2, however, shows only the functional blocks realized by various combinations of the above hardware/software collaborations. Internal blocks of the prize awarding apparatus 24 may be shared with those of the mail server 22. A page data storage 30 may for example store all the page data the mail server provides to the user terminal 12. Here the page data storage 30 at least stores the homepage data of the prize awarding site 16 and pages related to the prize awarding service.

As mentioned, the browser, when initiated after the connection between the user terminal 12 and the internet 14 is established, first accesses the homepage stored in the page data storage 30. A access detector 32 detects access by the user terminal 12 to the homepage and identifies the user using a cookie set at the browser or pre-registered user identification information. The access detector 32 stores data 48 including access information (hereinafter referred to as user data 48) to a user data storage 46 for each user. The access detector 32 informs a process initiator 34 that a certain user has accessed the homepage.

The process initiator 34 initiates a prize module 40 stored in a process storage 36 on receipt of the notice from the access detector 32. The prize module 40 is a bundle of programs for awarding a prize to the user terminal 12 and can be realized using a CGI, Common Gateway Interface, installed in the mail server 22. The prize module 40 retrieves image data pre-stored in an image data storage 42 and outputs the data to the screen of the user terminal 12. The image data storage 42 holds therein images for advertising the sponsors of the prizes. The prize module 40 starts to operate when a user accesses the homepage. A slot machine starts to rotate on the screen. The process storage 36 prohibits the user from accessing any other page linked to the homepage until the rotation stops.

A probability adjusting unit 44 in a prize manager 38 detects in a manner explained later the access frequency in plural time spans for each user based on the latest user data 48 stored in a user data storage, and manipulates the probability of winning the prize based on the detected value. The probability adjusting unit 44 defines the probability for each user by referring to the user data storage 46 and determines win or loss status of the user according to the probability. The determination is sent to the prize module 40, which has different program routines for winners and losers and which informs the user of the result and so on.

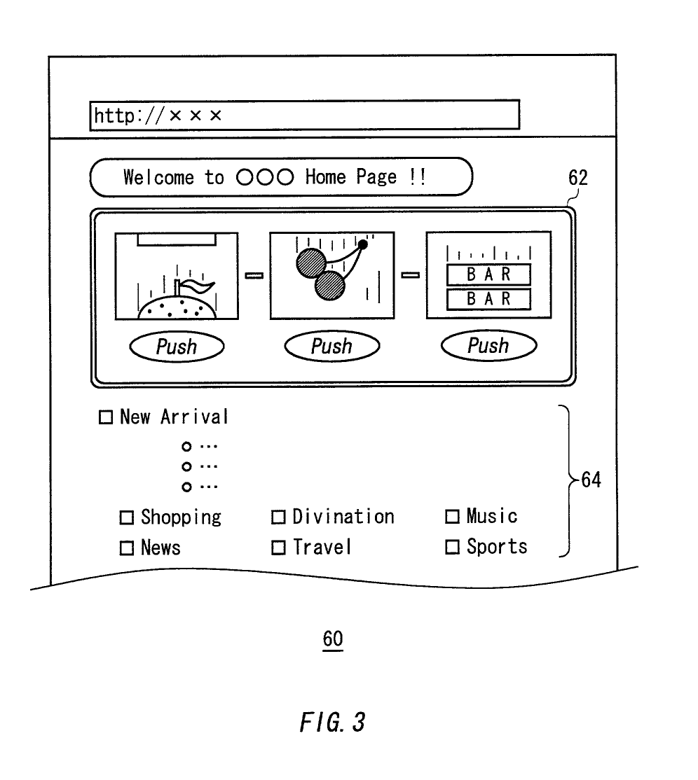

FIG. 3 shows a screen 60 displayed on the user terminal 12 when the user accesses the homepage. A slot machine image area 62 appears above a link area 64 for the various information categories an ordinary portal site provides. Three drums of the slot machine start to rotate in the slot machine area 62. The drums stop when the user pushes “Push” buttons. The user wins when the same or predetermined three items appear in the window.

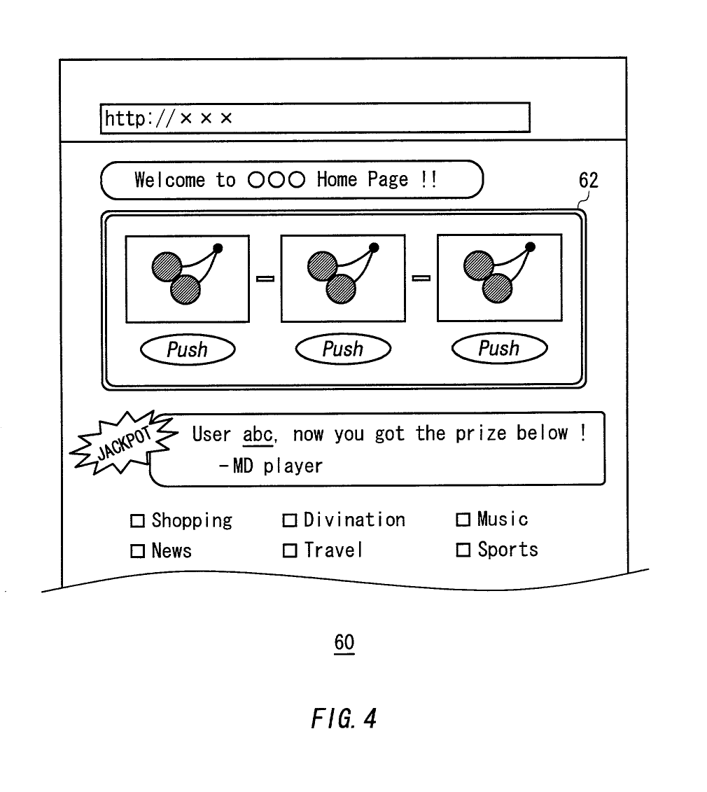

FIG. 4 shows the screen 60 in which three cherries appear when the machine is stopped. In the screen, “Jackpot” is highlighted and the user is informed of having won the prize, which is an MD player. It is naturally preferable to adopt plural ranks of prizes in the same manner adopted in slot machines in the real world. On the other hand “Sorry, this time you lose. Try again!” or the like (not shown) may be displayed for users who have lost the game, in order to invite them to enter.

Access to other pages is locked, even when the user clicks an arbitrary part in the link area 64, until the determination regarding win or loss is completed, so that the user can be sure of knowing the result. In another embodiment, a button to skip the prize giving process is provided on the screen. The slot machine area 62 may be deleted and any access lock may be released when the user activates the button.

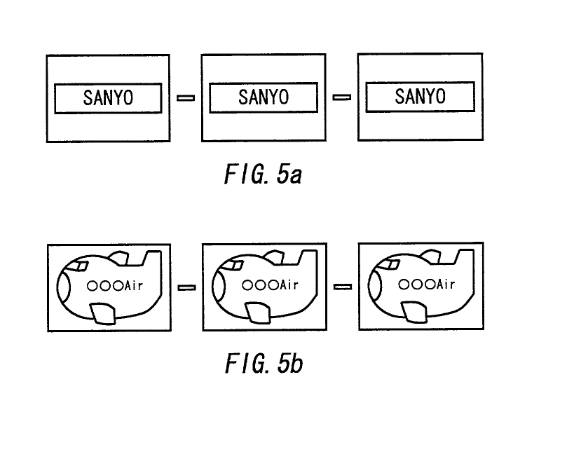

FIGS. 5a and 5b show a representation or advertisement image of the sponsor of the prize built into the slot machine process and displayed on the user's information terminal. In FIG. 5a, a sponsor's logo “SANYO” is displayed, imitating “BAR” in a slot machine. In FIG. 5b, another sponsor's trademark which is a symbolized by an airplane with a logo “OOO Air” is used. In both cases, the user has won the prize by getting Jackpot combinations. From a business model point of view, when a Jackpot combination includes a representation of a sponsor, the prize may be one provided by the sponsor so that further advertising impact for the sponsor is achieved. The representation of a sponsor may be composed so that the user can click it, just like a banner, to link the user to the sponsor's site. The prize awarding site 16 may set a service charge for each sponsor based on the frequency or the number of appearances of the sponsor in the slot machine windows, when a sponsor wishes to have a greater level of exposure to users.

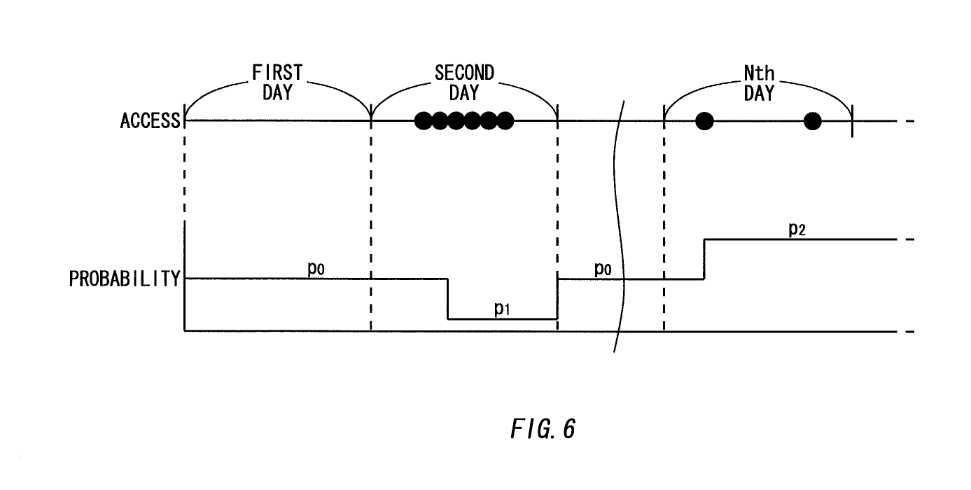

FIG. 6 shows how to adjust the win probability at the probability adjusting unit 44. Two time frames for measuring access frequency, namely, “day” and “hour” are employed. The probability for a certain user is increased when the user accesses the homepage more than n days consecutively. When a certain user accesses more than fifty times in one hour, on the other hand, the probability may be decreased at least during that day. The probability may be slightly decreased when a user accesses more than ten times in ten minutes to avoid the user easily winning a prize in the aforementioned fifty times. More generally, it is possible to employ more than two probability levels taking into consideration the respective access status.

In FIG. 6, the initial probability of the user in question on the first day is p0. The probability is, however, temporarily decreased to p1, as the access frequency on the second day was too high. The probability goes back to the initial value p0 at the end of the second day. The user accesses everyday and the probability goes up to p2 on the n-th day. Further increases in the probability for further consecutive access may be implemented. In one embodiment, the probability is set to one for a period to ensure that a user who has accessed for more than one hundred consecutive days is awarded a prize.

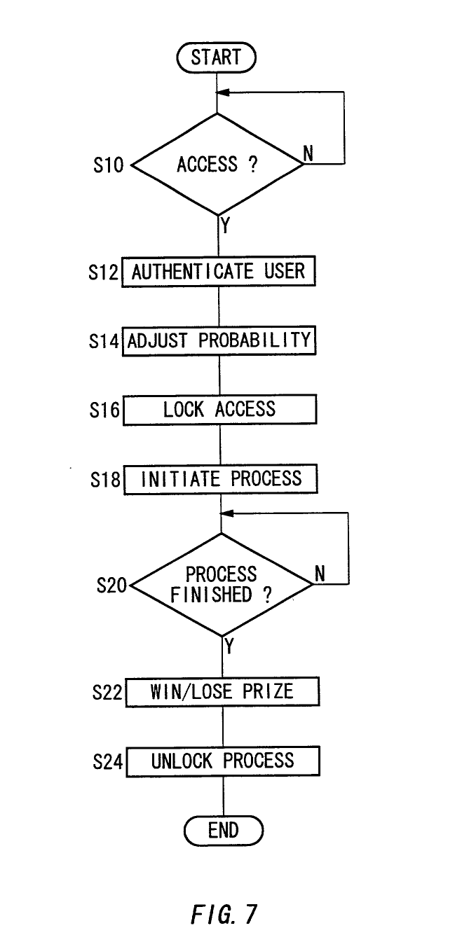

FIG. 7 is a flowchart summarizing the process described above. The access detector 32 detects continuously users' access (S10N). Access to the homepage of the prize awarding site occurs when a user activates the browser. The access detector 32 detects the access (S10Y). The user is identified (S12) and the 48 is recorded in the user data storage 46 (S12). Access frequency is determined based on the recordation. The probability adjusting unit 44 controls the probability by referring to the user data storage 46 (S14).

User access outside the page is locked (S16). The process initiator 34 initiates the prize giving process and the slot machine starts to rotate (S18). The CPU at the server end can process all of the above steps almost immediately. The user will feel that the rotation of the machine starts almost immediately following user access to the homepage. The prize giving process continues until the user clicks all of the “Push” buttons (S20N). When clicked (S20Y), the probability adjusting unit 44 determines the win or loss of the user (S22). The result is displayed and the access lock is cancelled. The entire process is now completed and the user terminal 12 goes back to its normal operation mode (S24).

Although the present invention has been described by a few embodiments, it should be understood that many variations and modifications may be made within the spirit and the scope of the present invention which is defined only by the appended claims. A few such modifications are as follows.

The present invention is naturally applicable to prize provision means other than the slot machine. A dice game is another example. Arbitrary prize awarding processes can be employed as long as there is an entertainment aspect is present. It is preferable that the process includes a function to control the win/loss probability and can be completed within an acceptable time period.

The manipulation of the probability can depend on a user's personal data, attributes or any personal situation. The probability may be increased on a day the user buys an expensive piece of merchandise through the prize awarding site prize awarding site 16 or simply on the user's birthday.

What is claimed is:

1. A prize awarding method comprising:
detecting access from a user via a network to a predetermined page;
initiating a prize awarding process providing amusement when the access is detected; and
allowing the user win a prize at the end of the process based on a certain probability;
wherein the process is carried out at a moderate speed so that the user can understand progress of the process and wherein the process is completed before the user gains access to arbitrary information residing inside or outside the page.

2. The method of claim 1, wherein the process is carried out at the moderate speed by decreasing CPU performance.

3. A prize awarding method comprising:
detecting access from a user via a network to a predetermined page;
initiating a prize awarding process providing amusement when the access is detected;
allowing the user to win a prize at the end of the process based on a certain probability; and
manipulating the probability based on frequency of access by the user.

4. The method of claim 3, wherein the probability is decreased when the frequency of user access is unacceptably high over a relatively short period of time.

5. The method of claim 3, wherein scheme of the manipulation is indicated to the user.

6. The method of claim 3, wherein the frequency is determined using multi-resolutional analysis and wherein the probability is adjusted according to the evaluation.

7. The method of claim 6, wherein the multi-resolutional analysis is conducted by determining the frequency in a plurality of different time spans.

8. The method of claim 1, wherein the process is executed and representation of a sponsor of the prize is built into the process and displayed on the user's information terminal.

9. The method of claim 3, wherein the process is executed and representation of a sponsor of the prize is built into the process and displayed on the user's information terminal.

10. The method of claim 1, wherein the network is the Internet and wherein the page is a page viewed on a WWW browser.

11. The method of claim 3, wherein the network is the Internet and wherein the page is a page viewed on a WWW browser.

12. The method of claim 1, wherein the process includes running a virtual slot machine and offering a prize for a rare combination of figures.

13. The method of claim 3, wherein the process includes running a virtual slot machine and offering a prize for a rare combination of figures.

14. The method of claim 1, wherein the user's access to arbitrary information is locked until the process is completed.

15. A prize awarding apparatus comprising:
a detector which detects access from a user via a network to a predetermined page;
a process storage which stores a prize awarding process providing amusement to the user:
a process initiator which initiates the process when the access is detected: and
a prize manager which allows the user to win the prize at the end of the process based on a certain probability;
wherein the process is carried out at a moderate speed so that the user can understand progress of the process and wherein the process is completed before the user gains access to arbitrary information residing inside or outside the page.

16. The apparatus of claim 15, wherein the process is executed and representation of a sponsor of the prize is built into the process and displayed on the user's information terminal.

17. The apparatus of claim 15, wherein the user's access to arbitrary information is locked until the process is completed.

18. A prize awarding apparatus comprising:
a detector which detects access from a user via a network to a predetermined page;
a process storage which stores a prize awarding process providing amusement to the user:
a process initiator which initiates the process when the access is detected:
a prize manager which allows the user to win the prize at the end of the process based on a certain probability; and
a probability adjusting unit which manipulates the probability based on frequency of access by the user.

19. The apparatus of claim 18, wherein the process is executed and representation of a sponsor of the prize is built into the process and displayed on the user's information terminal.
